(19) United States
(12) Patent Application Publication
(10) Pub. No.: US 2006/0064365 A1
(43) Pub. Date: Mar. 23, 2006

(54) System and method for audit sampling

(76) Inventor: William Frederick Yancey, Dallas, TX (US)

Correspondence Address: Mr. Christopher John Rourk;GODWIN PAPPAS LANGLEY RONQUILLO LLP, 1201 Elm Street, Renaissance Tower, DALLAS, TX, 75270, US

(21) Appl. No.: 10/945,724

(22) Filed: Sep. 21, 2004

(51) Int. Cl. G06Q 40/00

(52) U.S. Cl. 705/35

(57) ABSTRACT

A method for auditing financial records is provided. The method includes setting a High Threshold such that a 100% detail examination is performed on all records with values exceeding the High Threshold. A Low Threshold such that none of the records with values below that Low Threshold are sampled or examined. Two or more strata spanning the range between the Low and High Thresholds specified and evaluated using the coefficient of variation of each stratum to evaluate the stratification boundaries and guide the determination of sample size.

### FIELD OF THE INVENTION

The present invention pertains to the field of audit sampling, and more particularly to a system and method for sampling data that allows the sample size of large data groups to be optimized.

### BACKGROUND OF THE INVENTION

Methods for auditing large numbers of records are known in the art. Such methods typically require that a random sample of all records be taken, where the sample size is arbitrarily set. For example, a sample size might be set on a predetermined number of strata, a predetermined sample size, or other predetermined sampling criteria that might not result in an efficient or effective sampling plan. Such methods often result in samples that include large numbers of small dollar items that represent a small percentage of the total dollars in the population. As a result, a significant amount of time can be expended reviewing materials that are only of marginal relevance to the audit results.

### SUMMARY OF THE INVENTION

In accordance with the present invention, a system and method for auditing financial records are provided that overcome known problems with auditing financial records.

In particular, a system and method for auditing financial records are provided that reduce the amount of resources that are required to perform the audit by optimizing the number of records that need to be sampled.

In accordance with an exemplary embodiment of the present invention, a method for auditing financial records is provided. The method includes setting a High Threshold such that all records above that High Threshold are 100% audited (also known as detailing or census). Then a Low Threshold is set such that none of the records below that Low Threshold are examined. Two or more strata are then set whose boundaries span the range of values from the Low Threshold to the High Threshold. The coefficient of variation within each stratum is used to evaluate the strata boundaries and determine the sample size for the sampled strata.

The present invention provides many important technical advantages. One important technical advantage of the present invention is a system and method for auditing financial records that uses a coefficient of variation to set the stratum boundaries and determine the sample size for each stratum. Records in a stratum that have a low coefficient of variation are not sampled as frequently as data having a high coefficient of variation.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a flowchart of a method for performing audits in accordance with an exemplary embodiment of the invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

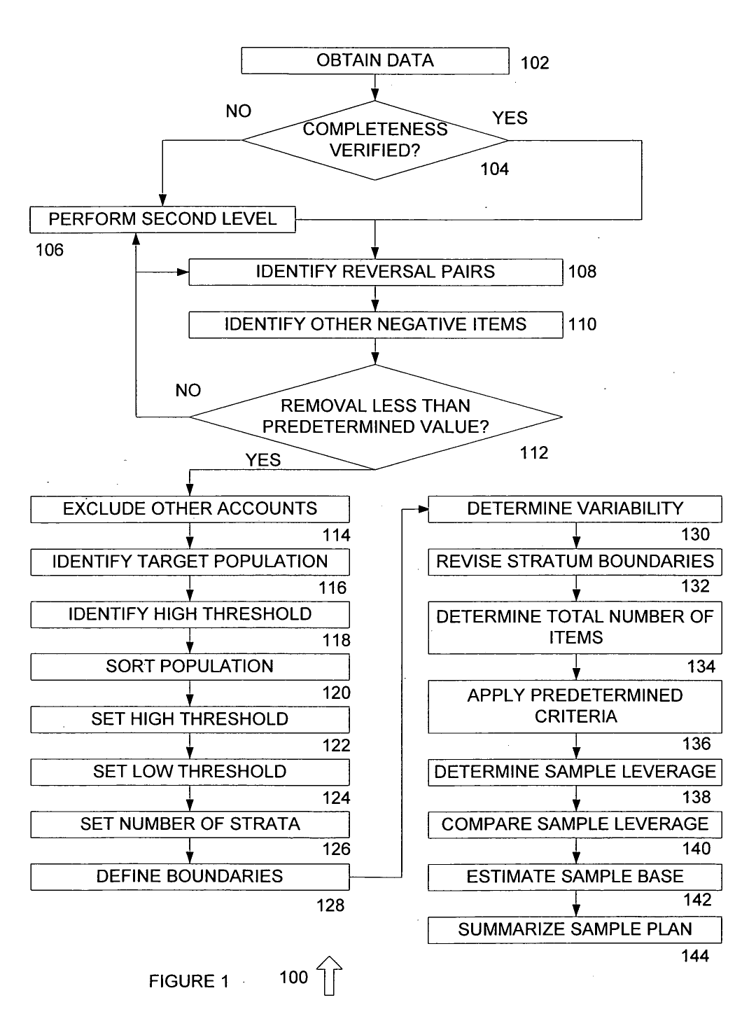

FIG. 1 is a diagram of a method 100 for sampling large data sets for financial audits in accordance with an exemplary embodiment of the present invention. Method 100 allows data to be sampled in a manner that optimizes the use of resources without affecting the quality of the audit.

In one exemplary embodiment, method 100 can be applied when a large number of data records are being audited, such as files with more than 5,000 records or rows of data. Likewise, method 100 can be used when the data is being audited from accounting, tax, financial, or other operations. Method 100 can also be useful when the data distribution is skewed, so that there are more items with small dollar magnitude than large dollar magnitude. One result from the use of method 100 is that quantities such as total error, total value, total valid transactions, allocation among jurisdictions, allocation among segments, or other amounts can be estimated with an efficient statistical sampling plan.

Method 100 can be used when all of the data desired for the estimate is not readily available in a computer data file. In many financial, accounting, and tax applications, the computer data files have some fields, but additional supporting documents, such as invoices, must be examined to determine the error, total value, or other measure of interest. Method 100 is a stratified random sampling method that eliminates the associated cost with examining all individual records, such as retrieving and reviewing all supporting documents. The type of applications where such audits may be required include, but are not limited to, financial statement audits, internal audits, sales and use tax audits, excise tax audits, unclaimed property audits, personal property audits, payroll audits, income tax deduction audits, income tax revenue audits, inventory valuation audits, loan loss reserve estimation audits, accounts receivable verification audits, accounts payable audits, fixed asset audits, and other suitable audits. The audits described herein may also be known as tests, examinations, reviews, or inspections. Amounts are described herein as dollars, but other suitable currency units or measures can also or alternatively be used.

At 102, data is obtained, such as from a download of records stored in accordance with predetermined data formats, such as those used in conjunction with accounting, spreadsheet, database or other suitable computer or printed records. The method then proceeds to 104.

At 104, the completeness of the data is verified, such as by reconciliation, tracing, trend analysis, ratio analysis, or other suitable analysis. If the verification indicates the data obtained from the download is not complete, the method proceeds to 106 where a second level of verification is implemented, such as by checking individual records, fields, application programming interfaces, or other suitable variables. If the download is verified, the method proceeds to 108.

At 108, reversal pairs are identified, such as a positive and negative amount related to the same invoice that exactly offset each other. In one exemplary embodiment, these reversal pairs can be extracted from the population, audited as a separate group, or otherwise processed. The method then proceeds to 110.

At 110, other negative items that are not reversal pairs are identified, such as a negative amount of $500.00 that reverses or reclasses five $100.00 items. In one exemplary embodiment, these negative items can be excluded, together with their offsetting positive items from the population. Likewise, they can be independently tracked for independent auditing, or otherwise processed. The method then proceeds to 112.

At 112, it is determined whether the removal of negative results in the population has a magnitude of less than a predetermined value, such as five percent, of the total sum of positive items. If the reduction in magnitude is less than the predetermined amount, then the method proceeds to 114, otherwise it returns to 106 or 108.

At 114, it is determined whether other accounts or transaction types can be excluded from further analysis. In one exemplary embodiment, accounts that are independently audited by other authorities, such as state or federal authorities, can be excluded. Likewise, transaction types that are independently verified or audited, such as credit card transactions, employee benefits, tax payment transactions, or other particular transaction types, can be excluded. The method then proceeds to 116.

At 116, the population that remains after the above steps is identified as the target population. Descriptive statistics on the dollar amounts in the target population are then generated, including but not limited to the population size (number of items in the target population), population base (total dollars/numbers in the target population), mean, standard deviation, skew, minimum, maximum, or other suitable measures. The method then proceeds to 118.

At 118, a High Threshold is identified. In one exemplary embodiment, the High Threshold is the dollar amount such that all records with a dollar amount greater than or equal to the High Threshold will be examined in detail (also known as actual basis, 100% exam, census, or other suitable values). The method then proceeds to 120.

At 120, the population is sorted, such as by sorting in descending order from maximum to minimum to facilitate the determination of the High Threshold or in other suitable manners. In one exemplary embodiment, the High Threshold can be the amount such that the number of items above the High Threshold is less than a predetermined percentage of the total population, such as one percent of the population size. For example, if the population size is 52,000 rows of data is a spreadsheet or database, then the High Threshold can be set to the top 520 rows of the population when it is sorted in descending order. The High Threshold can be set higher or lower depending on the audit policies of the auditing authorities, cost/value limitations on the total number of items that can be examined relative to the total value of the audit, or other suitable data. The method then proceeds to 122.

At 122, the High Threshold is set to a suitable level, such as at a value having two or three significant digits. In one exemplary embodiment, if the High Threshold is estimated to be $123,947.65, then the number of significant digits can be two ($120,000) or three ($125,000). The number of significant digits can be set based upon the required accuracy of the audit or other suitable data. The method then proceeds to 124.

At 124, a Low Threshold is determined. In one exemplary embodiment, the Low Threshold is the dollar amount below which no items will be examined, such as because those items are costly to examine and do not change the total estimate by more than a predetermined amount, such as an amount equal to the required accuracy of the audit. In one exemplary embodiment, the Low Threshold can be set to a value on the order of three orders of magnitude below the High Threshold for large financial data populations. In this exemplary embodiment, if the High Threshold is $100,000, then a starting point for setting the Low Threshold is $100. The reason for this relationship between High and Low Thresholds has been empirically determined, in that most large accounting data populations have a similar skew.

The Low Threshold can also be adjusted so that approximately less than two percent of the total population base or magnitude is below the Low Threshold level. For example, the two percent guideline may be used when audit sampling is required to achieve precision within five percent. The two percent exclusion below the Low Threshold is therefore less than the tolerable precision in the overall estimate, in this exemplary embodiment.

In another exemplary embodiment, if an estimate of error or adjustment for the items below the Low Threshold is desired, a nonstatistical projection of the results from the stratum about the Low Threshold can be projected onto the excluded population below the Low Threshold. For example, if the error rate estimated for the stratum above the Low Threshold is 12% and the excluded population below the Low Threshold has a base of $2,000, then the projected error is 12%×$2,000=$240. One exemplary purpose of projecting error rate onto the excluded population is to achieve a reasonable estimate of the effect of the excluded population on the audit values. Since the excluded population is not sampled, the sampling risk for the excluded population cannot be evaluated by statistical methods, but must be estimated in a suitable manner. The method then proceeds to 126.

At 126, the number of strata between the Low and High Thresholds is set and the boundaries of those strata are specified. In one exemplary embodiment, a predetermined number of strata may be required, such as three. In another exemplary embodiment, the number of sampled strata can be set based on the ratio, R, of the High Threshold to the Low Threshold. In this exemplary embodiment, where the High Threshold is H=$100,000 and the Low Threshold is L=$100, then R=1,000. If the number of strata J=3, then the third root of R is r=10. Thus, L×R=L×r^{J}=$100×10³%=$100,000=H. The boundaries of the sampled strata are then defined at 128. For example, if the ratio of the high to low boundary for each stratum is r=10, the High Threshold is $100,000, the Low Threshold is $100, and the number of strata is three, then the three strata are defined as $100 to $1,000; $1,000 to $10,000; and $10,000 to $100,000. The method then proceeds to 130.

At 130, the coefficient of variation (c.v.) or other suitable estimate of the variability of the amounts in the sampled strata is determined. This c.v. is defined as the ratio of the standard deviation of the stratum by the mean for the stratum. In one exemplary embodiment, if the c.v. or other figure of variability for any stratum is greater than 1.0, then the stratum boundaries can be adjusted, the number strata can be changed, or other suitable measures can be provided. In another exemplary embodiment, if the c.v. or other figure of variability for any sampled stratum is 50% greater than the c.v. or other figure of variability of any other sampled stratum, then the stratum boundaries can be adjusted, another stratum can be added, or other suitable processes can be implemented. The method then proceeds to 132.

At 132, the stratum boundaries or number of stratum are revised until all the sampled strata have a c.v. or other figure of variability of less than 1.0 and the c.v. of the sampled strata are close to each other within a predetermined amount. The total number of items to be examined is then determined at 134. This total includes the number of sample items in the sampled strata and the detail stratum above the High Threshold. This total number can be determined by budget constraints by the client on the total number of items to be examined, government policy on the minimum number of sample items per sampled stratum, a predetermined statistical sample size formula, or other suitable criteria. The method then proceeds to 136.

At 136, if it is determined that none of the sample size constraints listed above applies, then a predetermined criteria can be applied, such as to divide the expected rate of nonzero items by the desired number of observed errors or other suitable or empirically determined amounts. For example if the expected rate of nonzero items is 2 percent (also known as 0.02) and the desired number of observed errors is at least 5, then the sample size per stratum is 5/0.02=250. In this exemplary embodiment, the desired number of observed errors in the numerator can be based on Internal Revenue Service (IRS) statistical sampling policy that the minimum number of items required for a projection is “three to five errors per stratum,” or other suitable criteria based on the number of errors per stratum or other suitable criteria.

Likewise, the minimum number of sample items per stratum may be limited to a predetermined number, such as not less than 30 or other empirically determined numbers of observations that may be required to obtain a reasonable estimate of the standard deviation. Likewise, other suitable statistical analysis procedures can be used to determine the minimum sample size that is statistically relevant.

In another exemplary embodiment, the maximum number of sampled items per stratum may be set to a predetermined amount, such as not more than 50 percent of the items in that stratum's population. If the number of sample items is greater than approximately 50 percent, then the finite population correction factor (f.p.c.) can become significant and the statistical results may need adjustment. If the sample size is close to or above 50 percent, then it may be determined that detailing the stratum (also known as a 100% examination) is suitable. The method then proceeds to 138.

At 138, sample leverage is computed for each sampled stratum. Sample leverage for a stratum is defined as the population base divided by the sample size. In an exemplary embodiment, a $1,500,000 population base divided by 200 sample items equals $7,500 of sample leverage. The sample leverage provides a way of estimating the impact on the population if an average sample item in the stratum is a complete error.

The relevance of sample leverage is that in many audits of accounting data, the results are discrete: any one record is usually completely correct or completely wrong for the purpose of the audit. For example, if a purchase was not taxed, usually the entire purchase amount for that record was not taxed. The method then proceeds to 140.

At 140, the sample leverage amounts are compared between the sampled strata. The sample leverage can be relatively similar in magnitude across the stratum in one exemplary embodiment. If they are not relatively equal, then the sample size can be adjusted, stratification boundaries can be to make them more equal, or other suitable processes can be used. In one exemplary embodiment, if stratum B has a sample size of 100, stratum B population base of $10 million, and a stratum B sample leverage of $100,000; and stratum C has a sample size of 50, stratum C population base of $10 million, and sample leverage of $200,000; then the sample size may be adjusted to 75 for both strata B and C so that they both have a sample leverage of $133,333. It is unlikely that sample leverage will be exactly the same across strata. If the difference between the lowest and highest sample leverage is within a predetermined amount, such as 20 percent, then it may be determined that is close enough. The method then proceeds to 142.

At 142 the sample base dollars is estimated in each stratum by selecting a random sample of the specified size, and the sample mean is computed. The sample mean is then compared to the population mean. If the difference between the sample and population means is less than a predetermined amount, such as 10 percent of the population mean, a different random sample can be set using a different random seed number. If the difference between the sample and population means is greater than 10 percent, then the sample size can be increased. The purpose of comparing the sample mean to the population mean is to evaluate whether the sample base is representative of the population base.

It may also be difficult to achieve equal c.v., equal sample leverage, and a total number of items to be examined that fits a project budget. A recursive process can be used to obtain a sample size that achieves predetermined objectives. The method then proceeds to 144.

At 144, a final summary report of the sampling plan can be prepared that shows the following for each stratum and the target population: stratum identifier, lower boundary, upper boundary, population size, population base dollars, population mean, population standard deviation, population coefficient of variation, sample size, sample leverage, sample mean, the difference between sample and population mean as a percentage of population mean, an other suitable data.

APPENDIX 1 is an exemplary case study embodying concepts of the present invention. In one exemplary embodiment, equalization of the coefficients of variation between the strata can be used to optimize the number strata, or can also be used where the number of strata is specified by a government agency or other authority.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. A method for auditing financial records comprising:
setting a High Threshold such that a 100% detail examination is performed on all records with values exceeding the High Threshold;
setting a Low Threshold such that none of the records with values below that Low Threshold are sampled or examined; and
setting two or more strata spanning the range between the Low and High Thresholds specified and evaluated using the coefficient of variation of each stratum to evaluate the stratification boundaries and guide the determination of sample size.
